(19) United States
(12) Patent Application Publication
(10) Pub. No.: US 2005/0183081 A1
(43) Pub. Date: Aug. 18, 2005

(54) Installation of a compiled program, particularly in a chip card

(75) Inventors: Lilian Burdy, Le Tholonet (FR); Ludovic Casset, Paris (FR); Damien DeVille, Lille (FR); Antoine Requet, Marseille (FR)

Correspondence Address: BURNS DOANE SWECKER & MATHIS L L P, POST OFFICE BOX 1404, ALEXANDRIA, VA, 22313-1404, US

(73) Assignee: GEMPLUS, Gemenos (FR)

(21) Appl. No.: 10/491,916

(22) PCT Filed: Oct. 21, 2002
(86) PCT No.: PCT/FR02/03599

(30) Foreign Application Priority Data
Oct. 31, 2001 (FR) 01/14187

(51) Int. Cl. G06F 9/445

(52) U.S. Cl. 717/174

(57) ABSTRACT

The invention relates to the installation of a compiled program, particularly in a chip card. In order to reduce the storage location of a compiled program (PGC) to be installed in a data processing device, such as a chip card (CP), installation information detected in the compiled program, which is also necessary for the installation of other programs in the device and which is only necessary for the installation of the compiled program respectively, is reformulated in first and second additional components (CAD1, CAD2). The compiled program is installed (C3, C4) and, in particular, checked according to pre-determined information in the additional components (CAD1, CAD2) in the device. The second additional component (CAD2) can then be deleted (C5) prior to the running of the compiled program.

The present invention concerns the installation of a program compiled in an intermediate language, such as a service application or library which was written initially in an object-oriented high level language and which must be downloaded and run in a data processing device with a low memory and processing capacity. The data processing device is for example a portable electronic object such as a chip card.

More particularly, the invention relates to the process of checking a compiled program loaded in the data processing device, when it is installed in it.

It is known that a code checker in a data processing device checks the low level security properties in a loaded compiled program in order to ensure that the loaded code cannot have an influence on the security mechanisms of the processing device included in particular in the interpreter and the memory management means. The checking consists principally of analysing the code loaded, comparing information contained in the compiled program and keeping some of it. However, the integration of a code checker in a processing device, such as a chip card, whose resources are relatively limited poses memory problems both in terms of sizing of the memory and the time necessary for performing the checking operations.

In order to improve the integration of a program checker compiled in intermediate language, the compiled program can be modified outside the processing device whilst ensuring that the program has the same signification but facilitates checking. However, modifying the compiled program does not make it compatible with the processing devices which were able to receive it initially without change.

The objective of the present invention is to make the installation of a compiled program in a data processing device more rapid without modifying the interpretation of the program.

To achieve this objective, a method for installing a program consisting of several components and compiled outside a data processing device in order to be run in the latter is characterised in that it comprises the steps of:
detecting outside the data processing device predetermined installation information in the components of the compiled program,
constructing first and second additional components containing predetermined information detected respectively which are reformulated and also necessary to the installation of other programs in the data processing device and which are reformulated and are necessary only for the installation of the said compiled program,
loading from the outside the compiled program and the first and second additional components in the data processing device, and
installing the compiled program loaded depending on the predetermined information reformulated in the first and second additional components.

Thus the invention does not add information to the compiled program to be run and is an effective solution for rapidly accessing information necessary for the installation of the program by virtue of an optimisation in terms of access time and memory of the process of checking the compiled program.

In order to reduce the size of the memory location occupied by the compiled program after its installation, the method comprises the step of deleting the second additional component in the data processing device prior to any running of the compiled program.

In addition, the predetermined information in the compiled program loaded cannot be partially stored.

According to another aspect of the invention, so as to adapt to any data processing device in a category, such as a chip card, the method of the invention and particularly the pre-processing of the compiled program comprising the detection and construction steps performed outside the processing device, the method comprises a recognition of the first and second additional components in the data processing device in order to store only the loaded compiled program and not store the additional components if the latter are not recognised by the data processing device, and to store the compiled program without the predetermined information detected but with the additional components if the latter are recognised by the data processing device.

According to a preferred embodiment, the predetermined information detected may relate to the format and typologisation of program compiled, and the installing step comprises a step of checking the format of the compiled program loaded and a step checking the typologisation of compiled program loaded depending on the reformulated predetermined information.

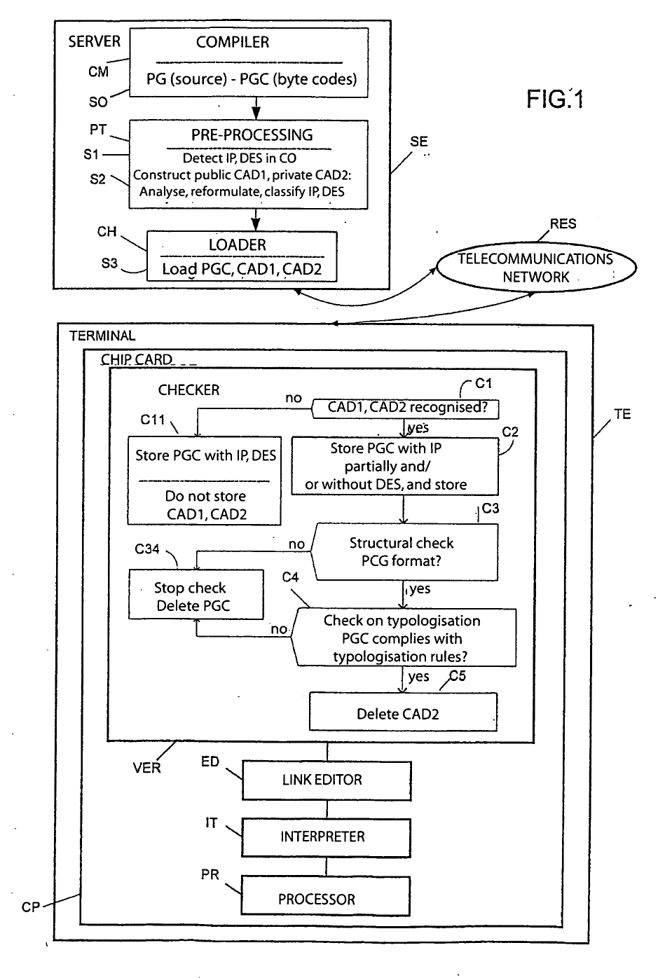

Other characteristics and advantages of the present invention will emerge more clearly from a reading of the following description of several preferred embodiments of the invention with reference to the single FIG. 1, which is a block diagram of a server and client system of the chip card typologisation in an accepting terminal, in which the principal steps of the method of installing a compiled program according to the invention are shown.

In FIG. 1, there is in a conventional manner a client/server system comprising software means for implementing the program installation method according to the invention. The client and server are connected through a telecommunications network of the RES Internet typologisation.

The client is a data processing device having a low memory and data processing capacity. Typically the client is a portable electronic object of the chip card typologisation CP, also referred to as a microcontroller card or integrated circuit card, removably housed in a reader of an accepting terminal TE. The chip card to which reference will be made hereinafter as an example of a data processing device is any known typologisation of chip card with or without contact, and may be a payment card, a telephone card, an additional card, a game card, etc.

The electronic terminal TE may be a personal electronic computer PC or a bank terminal or a point of sale terminal. According to another variant, the terminal TE and the chip card CA can be a mobile cellular radio telephone terminal and a removable telephone subscriber identity module SIM (Subscriber Identity Module). According to yet other variants, the data processing device may be a portable electronic object such as a personal digital assistant PDA (Personal Digital Assistant) or an electronic purse connected by modem to the telecommunications network RES.

The functional blocks depicted in FIG. 1 concern functions having a link with the invention and may correspond to software and/or hardware modules implanted respectively in the server SE and the chip card CP.

FIG. 1 also shows steps of installing the compiled program according to the invention which are implemented respectively by functional units in the server and the chip card CP.

The accepting terminal TE is considered to be transparent to the installation process, that is to say does not intervene directly in the processing relating to the installation of a compiled program.

The server SE, as an electronic means external to the card CP, is for example the server of an Internet site belonging to the editor of the card CP or to the editor of a source program PG to be downloaded in the card CP.

It will be assumed hereinafter that the source program PG to be loaded and run in the chip card CP was written initially in a high level language of the object oriented type such as Java language, or more particularly in Java Card language.

In a known manner, the server SE comprises a compiler CM which converts the program PG in Java Card source language into a compiled program PGC in intermediate language, also referred to as pseudo-code, composed of instruction words formed by bytes, referred to as byte codes, which are ready to be executed by an interpreter IT constituting the Java Card virtual machine in the chip card CP.

Within the meaning of the invention, the compiled program PGC is an application, that is to say a compiled file structured as several software components CO which may each correspond to a class of object, or to several classes of object grouped together in a package, or to an interface.

A component, such as a class, comprises predetermined information IP which, according to the invention, is necessary for the installation of the compiled program in the chip card CP. The information IP contributes to the checking of the compiled program PGC during the loading and before any running thereof in the chip card CP. The information IP essentially concerns the format and typologisation of the compiled program PGC. The checking of the format essentially concerns the syntax and/or the structure of the compiled program, for example the correct lengths of the attributes of the fields, the correct format of the instructions, etc. The typologisation relates to the semantics and syntax of the code in the components of the compiled program PGC so as to ensure coherence (consistency) of the instructions within a component and between the components of the compiled program and with components of other programs.

As shown in FIG. 1, for implementing the invention, the server SE comprises a compiled program pre-processing module PT which performs essentially two steps of the method of the invention outside the chip card CP: a detection step S1 for detecting predetermined information IP relating to the format and typologisation in the components CO of the compiled program PGC, and a construction step S2 for constructing two additional components CAD1 and CAD2.

At step S1, the pre-processing module PT detects predetermined information in the components CO of the compiled program PGC which relate to the format and typologisation of the program PGC and which will be used for the subsequent checking thereof in the chip card CP. The information detected is not extracted from the components CO but only copied in a predetermined memory location in the server in order to construct the two additional components at the following step S2. The components CO in the compiled program PGC are thus not modified in the pre-processing module PT so that any chip card which receives a compiled program PGC and which is incapable of recognising the additional components CAD1 and CAD2 can run the unmodified compiled program.

The step of constructing additional components S2 consists principally of reformulating the predetermined information IP detected in the components CO and classifying them in two categories: the information necessary subsequently for the checking of other programs and the information only necessary for checking this compiled program, the latter being able to be deleted at least partially.

The pre-processing module PT analyses the predetermined information detected so as to reformulate it in order to access it more rapidly when the compiled program is installed and in order to reduce the size of the memory space located by the detected information IP, and more generally by the compiled program PGC. For example, the module PT eliminates redundancies in the detected information IP; according to a particular example, when two labels identify two inputs relating to two structures having the same content in a table relating for example to the field constant-pool, one of the two inputs is deleted at step S2.

The reformulated predetermined information IP is classified in two additional components CAD1 and CAD2 depending on whether or not this information is used solely for the installation of the compiled program PGC in the chip card CP.

The first additional component CAD1 contains information IP which is exported, that is to say accessible to other programs. This first reformulated predetermined information must be stored in the chip card CP after the installation of the compiled program PGC. This is because the first information, for example relating to class fields, may be used for checking in particular other applications or packets or components, that is to say other compiled programs imported subsequently in the chip card CP, and must therefore be accessible for subsequent checks in the card. The reformulated predetermined information classified in the first additional component CAD1 is thus accessible to all the applications and therefore to all the components of these installed in the chip card CP by virtue of their exported character.

Second reformulated predetermined information classified in the second additional component CAD2 is on the other hand information which is not exported in order to make it visible only within the compiled program PGC in question and to make it inaccessible from another package or another program. The second reformulated predetermined information will be used only for the installation of the compiled program PGC in the chip card CP, that is to say for checking only the program PGC, and will therefore not be kept in memory in the card after this installation so as to reduce the occupation of the memory by the program PGC, as will be seen below.

In order to construct the additional two components CAD1 and CAD2, the pre-processing module PT uses a known compiled program extension mechanism provided for by the designer of the Java Card language.

In a variant, instead of detecting predetermined information IP relating to the format and typologisation in the components CO of the compiled program PGC, step S1 copies a specific component called a “descriptor” DES which is included in the program PGC and which already contains the predetermined information IP necessary for the subsequent check. This variant concerns the context of the Java Card language for which the checking process must adapt to the execution context already existing in the chip card CP, that is to say the virtual machine IT in the latter cannot be modified.

According to the specification of the Java Card language, the descriptor component DES contained in a compiled program PGC is sufficient for analysing and checking all the components of the compiled program. However, searching for information in the descriptor DES included in the compiled program is not easy since the information contained in the descriptor is not classified in a specific order. Consequently, also for this variant, step S2 reformulates the predetermined information IP situated in the descriptor DES and classifies them in two additional components CAD1 and CAD2 having respectively the exported and non-exported characters. The first additional component CAD1 contains predetermined format and typologisation information which is obligatorily stored in order to check other imported programs and thus constitutes a descriptor component “export”. The second additional component CAD2 comprises predetermined format and typologisation information which is used only for checking the compiled program PGC and which cannot be accessible to another compiled program, that is to say to another class or another packet or interface not belonging to the compiled program PGC, and thus constitutes an “internal” descriptor component.

At the following step S3 in the server SE, a loader, possibly secure, CH assembles the compiled program PGC and the two additional components CAD1 and CAD2 for example in a web page which is downloaded into the chip card CP through the Internet RES and the terminal TE.

The downloading of the compiled program PGC from the server SE is performed in a transparent manner through a browser and an intermediate software module of the plug-in or proxy type of the terminal TE.

As also shown in FIG. 1, a checker VER included in the chip card CP executes other steps C1 to C5 of the compiled program installation method according to the invention.

As is known, the chip card CP also comprises a link editor ED and an interpreter IT constituting the Java Card virtual machine. All these software modules are located in the non-rewritable memory ROM and the non-volatile memory EEPROM of the chip card.

The checker VER checks the format and typologisation of the downloaded compiled program PGC and the link editor ED provides the links between the components CO of the downloaded program PGC with those of the applications already installed in the chip card CP. The interpreter IT is for example a virtual machine which interprets the standardised instructions of the compiled program PGC so that the latter is run in native code by the microprocessor PR of the card.

The checker VER commences the checking of the loaded compiled program PGC by examining the identifiers of the additional components CAD1 and CAD2 in the extension of the program PGC at step C1. If the checker does not recognise the additional components, the ROM and EEPROM memories of the chip card record the compiled program PGC with the non-reformulated predetermined information IP or the descriptor DES without change, as specified by the format of the program, and do not record the additional components CAD1 and CAD2 which the chip card ignores, at a step C11. In this case, the chip card will subsequently execute the program PGC without change, in a known manner.

On the other hand, if the checker VER recognises the additional components CAD1 and CAD2 at step C1, that is to say if the interpreter IT is capable of using the additional components, the non-volatile memory of the chip card stores the compiled program PGC and only partially stores the non-reformulated detected predetermined information IP contained in the program PGC, or does not store the non-reformulated detected descriptor DES contained in the program PGC, and also stores the additional components CAD1 and CAD2 at step C2.

Then the checker VER proceeds with two checking steps proper C3 and C4 using the reformulated predetermined information IP included in the additional components CAD1 and CAD2.

Step C3 is a structural check for ensuring that all the data in the compiled program PGC have a correct format for the subsequent execution by the interpreter IT. Step C3 examines not only the format of the fields of the compiled program PGC but also the format of other characteristics such as names, attributes, labels and instructions as well as correct correspondences of these in tables. These examinations are facilitated by easier and therefore more rapid access to the information IP relating to the format which was reformulated in the additional components CAD1 and CAD2. If one of the formats examined is incorrect at step C3, the checker VER stops the current checking and deletes the compiled program PGC and the additional components CAD1 and CAD2 in the memories of the card CP, at a step C34.

If the above structural check has been executed successfully, the checker VER checks at the following step C4 that the compiled program complies with the typologisation rules defined in the programming language, in this case the Java Card language. As at the previous step C3, the typologisation checking is facilitated by the organisation and reformulation of the predetermined data IP relating to the typologisation included in the components CAD1 and CAD2. The typologisation checking consists in particular of a semantic check on the fields of the compiled program, a syntactic check on the field and parameter signature, a check on the consistency of each code line supporting an instruction proper composed of an operation code and possibly one or more operands, a checking of the references to the field constant_pool, the consistency of the instructions between software components CO of the program, etc. If the checking of the typologisation indicates any inconsistency or error in the compiled program PGC, the checker VER stops the check and deletes the compiled program PGC and the additional components CAD1 and CAD2 in the memories of the card CP, at step C34.

At this stage, if the checks at steps C3 and C4 of the loaded compiled program PGC are positive, the compiled program PGC is accepted by the card CP for subsequent running by the interpreter IT.

However, the whole of the compiled program PGC with the additional components CAD1 and CAD2 contains much information which is not necessary for the subsequent running of the program, such as the typologisation information classified in the second additional component CAD2 of a private nature. At the following step C5, the checker directly deletes in the non-volatile memory of the chip card CP the private predetermined information combined in the second additional component CAD2. The deletion of the component CAD2 reduces the size of the memory space occupied by the program PGC and the first additional component CAD1.

The first component CAD1 is stored in memory since it contains public predetermined information which will subsequently be used to check in particular other compiled programs downloaded subsequently. By virtue of the pre-processing in the module PT of the server SE, the checker VER does not need to seek the information which will be scattered in the compiled program and which is necessary for subsequent executions. No structural modification is necessary to store the first additional component CAD1, with the exception that some data in it may be modified when editing links in the editor ED, but without imposing a change in the structure of the component CAD1. The compiled program is then ready to be executed in the interpreter IT.

Although steps C1 to C5 are shown in the checker VER before the link editor ED, the loading, checking, link editing and interpretation can be carried out in streaming mode, almost simultaneously as the compiled program PGC is loaded into the card CP. Before the interpretation, a compression of the compiled program with the components CAD1 and CAD2 can be provided, preparing and executing it partially or totally in the server SE or the card CP or both at the same time.

The invention is not limited to the preferred embodiment described above but concerns any program initially expressed in an object-oriented source language and any data processing device other than a chip card which has in particular a relatively small memory and processing capacity.

1. A method for installing a program consisting of several components and compiled outside a data processing device in order to be run in the latter is wherein it comprises the steps of:
detecting outside the data processing device predetermined installation information in the components of the compiled program,
constructing first and second additional components containing predetermined information detected respectively which are reformulated and also necessary to the installation of other programs in the data processing device and which are reformulated and are necessary only for the installation of the said compiled program,
loading from the outside the compiled program and the first and second additional components in the data processing device, and
installing the compiled program loaded depending on the predetermined information reformulated in the first and second additional components.

2. A method according to claim 1, comprising a step of deleting the second additional component in the data processing device prior to any running of the compiled program.

3. A method according to claim 1, according to which the predetermined information in the compiled program is not partly stored.

4. A method according to claim 1, comprising a recognition of the first and second additional components in the data processing device in order to store only the compiled program loaded and not to store the additional components if the latter are not recognised by the data processing device, and to store the compiled program without the predetermined information detected but with the additional components if the latter are recognised by the data processing device.

5. A method according to claim 1, according to which the predetermined information detected relates to the format and typologisation of the compiled program, and the installing step comprises a step of checking the format of the compiled program loaded and a step of checking the typologisation of the compiled program loaded depending on the reformulated predetermined information.

6. A method according to claim 1, according to which the predetermined information to be detected is included in a specific component of the compiled program.

7. A method according to claim 1, according to which the data processing device is a portable electronic object of the chip card type.
